(19) United States
(12) Patent Application Publication
(10) Pub. No.: US 2011/0045769 A1
(43) Pub. Date: Feb. 24, 2011

(54) COMMUNICATION DEVICE, COMMUNICATION SYSTEM, AND METHOD FOR COMMUNICATION

(76) Inventors: Masahiro Yoshioka, Tokyo (JP); Hiroshi Ichiki, Kanagawa (JP)

Correspondence Address: FROMMER LAWRENCE & HAUG, 745 FIFTH AVENUE- 10TH FL., NEW YORK, NY, 10151, US

(21) Appl. No.: 12/857,909

(22) Filed: Aug. 17, 2010

(30) Foreign Application Priority Data
Aug. 21, 2009 (JP) P2009-192330

(51) Int. Cl. H04B 5/00

(52) U.S. Cl. 455/41.1

(57) ABSTRACT

A communication device includes the following elements. A transmission and reception processing unit processes a transmission signal and a reception signal. A transmission amplifier is supplied with a binary transmission signal switching between a high level and a low level and is capable of making a choice between amplifying the transmission signal and entering a high-impedance state at an output. An antenna is supplied with a transmission signal output from the transmission amplifier. A comparator compares a signal received by the antenna with threshold values to obtain a reception signal, and supplies the reception signal to the transmission and reception processing unit. A capacitor is connected between the transmission amplifier and the antenna or between the antenna and the comparator. A control unit allows the transmission amplifier to be in the high-impedance state for a period during which the transmission and reception processing unit receives a reception signal.

### BACKGROUND OF THE INVENTION

1. Field of the Invention

The present invention relates to a communication device for performing noncontact near field communication, a communication system including the communication device, and a method for communication using the communication device.

2. Description of the Related Art

Recently, various types of systems for relatively high-speed wireless communication between two communication devices placed very close to each other at a distance of several millimeters to several centimeters have been proposed and been being put into practical use. For example, in such a system, parts of transmission paths connecting various information processing apparatuses to peripheral devices are used as wireless transmission paths. FIG. 22 illustrates the schematic configuration of the system in which communication is performed using a wireless communication path.

Referring to FIG. 21, a first device 10, serving as one communication device, includes a transmission and reception (hereinafter, “transmission/reception”) antenna 11. A second device 20, serving as the other communication device, includes a transmission/reception antenna 21. The transmission/reception antennas 11 and 21 are placed close to each other at a distance of, for example, approximately several millimeters, for two-way wireless communication.

FIG. 22 illustrates the detailed configuration of the related-art communication system including the communication devices illustrated in FIG. 21. Referring to FIG. 22, the communication system, indicated at 90, includes the first device 10 including the transmission/reception antenna 11 and the second device 20 including the transmission/reception antenna 21. The transmission/reception antennas 11 and 21 of the devices 10 and 20 are arranged close to each other.

The first device 10 includes a data transmitting and receiving unit 12, a transmission/reception separating circuit 13, an amplifier 14, a comparator 15, and the transmission/reception antenna 11. The transmission/reception antenna 11 is connected to the amplifier 14 from which a transmission signal is output and is also connected to the comparator 15 to which a received signal is supplied. The transmission/reception antenna 11 performs a wireless communication process with the transmission/reception antenna 21 of the adjacent second device 20. Transmission data generated by the data transmitting and receiving unit 12 is supplied through the transmission/reception separating circuit 13 to the amplifier 14. The data is amplified for transmission by the amplifier 14 and is then transmitted in a wireless manner from the transmission/reception antenna 11. A signal received by the transmission/reception antenna 11 is supplied to the comparator 15. The comparator 15 compares the level of the received signal with a threshold value and then supplies the result of comparison as reception data through the transmission/reception separating circuit 13 to the data transmitting and receiving unit 12.

The second device 20 communicating with the first device 10 has the same configuration as that of the first device 10. Specifically, the second device 20 includes the transmission/reception antenna 21, a data transmitting and receiving unit 22, a transmission/reception separating circuit 23, an amplifier 24, and a comparator 25.

FIG. 23 illustrates communication processing states of the devices 10 and 20.

As illustrated in part (a) of FIG. 23, it is assumed that transmission data including data “1” (high-level data) and data “0” (low-level data) which alternate every bit is wirelessly transmitted.

In this case, an output of the antenna on the transmission side has a signal waveform switching between the high level and the low level of the transmission data, as illustrated by a solid line in part (b) of FIG. 23. When the data is transmitted as a differential signal, a signal having a waveform with the opposite characteristics indicated by a dashed line in part (b) of FIG. 23 is simultaneously transmitted.

When the data is output from the transmission-side antenna, the reception-side antenna, placed close to the transmission-side antenna, receives data having a differential waveform in which change in transmission signal appear as levels, as illustrated in part (c) of FIG. 23. As for the received signal waveform, when the data is wirelessly transmitted as a differential signal, a signal waveform with the opposite characteristics is also detected as illustrated in a dashed line in part (c) of FIG. 23.

This received signal is amplified into a signal having a level in a predetermined range through an amplifying function included in the comparator included in a receiving circuit, as illustrated in part (d) of FIG. 23. The level of the amplified signal is compared to a positive threshold value and a negative threshold value. As a result of comparison, when the level of the signal is the positive threshold value or higher, the signal is held at the level of the data “1”. When the level of the signal is the negative threshold value or lower, the signal is held at the level of the data “0”. Thus, reception data illustrated in part (e) of FIG. 23 is obtained. The reception data in part (e) of FIG. 23 is the same as the transmission data illustrated in part (a) of FIG. 23. This means that the transmission data is correctly transmitted in a wireless manner.

Japanese Unexamined Patent Application Publication No. 2006-186418 discloses a technique for performing one-to-one high-speed noncontact communication between devices placed close to each other.

### SUMMARY OF THE INVENTION

In the wireless communication system with the configuration illustrated in FIG. 21, however, when both of the devices 10 and 20 simultaneously transmit signals, the signals transmitted from the transmission/reception antennas of the devices overlap each other, the signals are attenuated or cancel out each other. Disadvantageously, correct communication is not performed. For example, it is assumed that signals transmitted from the first device 10 correspond to a waveform illustrated in part (a) of FIG. 24 and signals transmitted from the second device 20 correspond to a waveform illustrated in part (b) of FIG. 24. It is also assumed that while the first device 10 transmits data of “010101” as illustrated in part (a) of FIG. 24, the second device 20 transmits data “0” at the time when the first device 10 transmits data “1”, as illustrated in part (b) of FIG. 24. This data “0” is transmitted as an acknowledge (Ack) signal that serves as reception confirmation response. The second device 20 transmits data “1” at the other times.

When the devices transmit the signals as illustrated in parts (a) and (b) of FIG. 24, the signals between the antennas 11 and 21 have states illustrated in part (c) of FIG. 24. Reception data demodulated from the signals through the comparator is as illustrated in part (d) of FIG. 24 and reflects the transmission data in part (a) of FIG. 24 as it is. Accordingly, the signals transmitted from the first device 10 are substantially correctly received, except for a period during which the Ack signal is transmitted. However, the Ack signal output from the second device 20 may not be correctly received by the first device 10.

Specifically, waveform segments at the transmission start timing and the transmission end timing of the Ack signal, serving as data “0”, correspond to signals at positions c1 and c2 in part (c) of FIG. 24. These signals attenuate or disappear because the last signal “1” transmitted from the first device 10 overlaps the Ack signal “0” transmitted from the second device 20. Consequently, the first device 10 may not correctly receive data.

As a related-art method for preventing attenuation or disappearance of such signals, wireless connection with full-duplex communication is used in some cases. Specifically, each communication device includes two antennas, namely, a transmission-only antenna and a reception-only antenna in order to prevent interference between transmission from the first device to the second device and transmission from the second device to the first device. Consequently, two-way transmission can be achieved without interference. Disadvantageously, it is necessary to provide two dedicated antennas for each communication device. Therefore, the area of installation of the antennas has to be increased two times or more. The cost is also increased.

The present invention has been made in consideration of the above-described disadvantages. It is desirable to excellently achieve two-way wireless near field communication using a pair of antennas.

According to a first embodiment of the present invention, a binary transmission signal switching between a high level and a low level is supplied to an antenna through a transmission amplifier so that the signal is wirelessly transmitted, the amplifier being capable of making a choice between amplifying the binary transmission signal and entering a high-impedance state at an output. A signal received by the antenna is compared to threshold values by a comparator, thus obtaining a reception signal.

A capacitor is connected to at least one of a portion between the transmission amplifier and the antenna and a portion between the antenna and the comparator. The transmission amplifier is allowed to be in the high-impedance state for a period during which a signal is received through the antenna.

According to the first embodiment of the present invention, an output from the transmission amplifier through the antenna is temporarily interrupted for a period during which a reception signal is obtained, so that the reception signal is not affected by a transmission signal. The reception signal obtained for this period can be properly compared to the threshold values by the comparator.

According to a second embodiment of the present invention, a binary transmission signal switching between a high level and a low level is supplied to an antenna through a transmission amplifier that amplifies the binary transmission signal so that the signal is wirelessly transmitted. A signal received through the antenna is compared to threshold values by a comparator, thus obtaining a reception signal.

A capacitor is connected to at least one of a portion between the transmission amplifier and the antenna and a portion between the antenna and the comparator. A predetermined bit is added to a transmission signal to be transmitted through the antenna for a period during which a signal is received through the antenna.

According to the second embodiment of the present invention, the bit added for the period during which the signal is received can eliminate the effect of the transmission signal on the reception signal. Thus, the reception signal obtained for this period can be properly compared to the threshold values by the comparator.

According to the first embodiment of the present invention, since the transmission amplifier is in the high-impedance state for a period during which a reception signal is obtained, a transmission signal output through the antenna is temporarily interrupted. Thus, the reception signal is not affected by the transmission signal. Two-way near field communication can be achieved using a pair of antennas.

According to the second embodiment of the present invention, since the predetermined bit is added to a transmission signal for the period during which a reception signal is obtained. Thus, the effect of the transmission signal on the reception signal can be eliminated. Two-way near field communication can be achieved using a pair of antennas.

### BRIEF DESCRIPTION OF THE DRAWINGS

FIG. 1 is a block diagram illustrating the internal configuration of a communication system according to a first embodiment of the present invention;

FIG. 2A is a perspective view of a master module and a slave module in an application of the communication system according to the first embodiment;

FIG. 2B is a perspective view of the master and slave modules connected to each other;

FIG. 3 is a perspective view of a first modification of the slave module in the application of the communication system according to the first embodiment;

FIG. 4 is a perspective view of a second modification of the slave module in the application of the communication system according to the first embodiment;

FIG. 5A is a perspective view of a master module and two slave modules in another application of the communication system according to the first embodiment;

FIG. 5B is a perspective view of the master module and the two slave modules connected to one another;

FIG. 6 is a perspective view of a master module and a slave module in another application of the communication system according to the first embodiment, the master and slave modules each including three planar antennas and two magnets;

FIG. 7 is a perspective view of a master module and a slave module in another application of the communication system according to the first embodiment, the master and slave modules each including three planar antennas, a single magnet, and a single magnetic sensor;

FIG. 8 is a perspective view of a master module and a slave module in another application of the communication system according to the first embodiment, the master and slave modules each including three planar antennas and a single magnet or magnetic sensor;

FIG. 9 is a perspective view of a master module and a slave module in another application of the communication system according to the first embodiment, the master and slave modules each including three planar antennas and a single magnet or magnetic sensor;

FIG. 10 is a flowchart of a transmission process of the communication system according to the first embodiment;

FIG. 11 is a flowchart of a reception process of the communication system according to the first embodiment;

FIG. 12 is a timing diagram illustrating the states of signals between antennas in the communication system according to the first embodiment;

FIG. 13 is a block diagram illustrating the internal configuration of a communication system according to a first modification of the first embodiment;

FIG. 14 is a block diagram illustrating the internal configuration of a communication system according to a second modification of the first embodiment;

FIG. 15 is a block diagram illustrating the internal configuration of a communication system according to a third modification of the first embodiment;

FIG. 16 is a block diagram illustrating the internal configuration of a communication system according to a second embodiment of the present invention;

FIG. 17 is a timing diagram illustrating signal waveforms relevant to encoding by encoding and decoding circuits in a communication system according to the second embodiment;

FIG. 18 is a diagram explaining a waveform upon decoding in the second embodiment;

FIG. 19 is a block diagram illustrating the internal configuration of a communication system according to a modification of the second embodiment;

FIG. 20 is a block diagram illustrating the internal configuration of a communication system according to another modification of the second embodiment;

FIG. 21 is a diagram illustrating the principle of a related-art communication system;

FIG. 22 is a block diagram illustrating the related-art communication system;

FIG. 23 is a waveform diagram illustrating wireless transmission signals; and

FIG. 24 is a timing diagram illustrating the states of signals in the related-art communication system.

### DESCRIPTION OF THE PREFERRED EMBODIMENTS

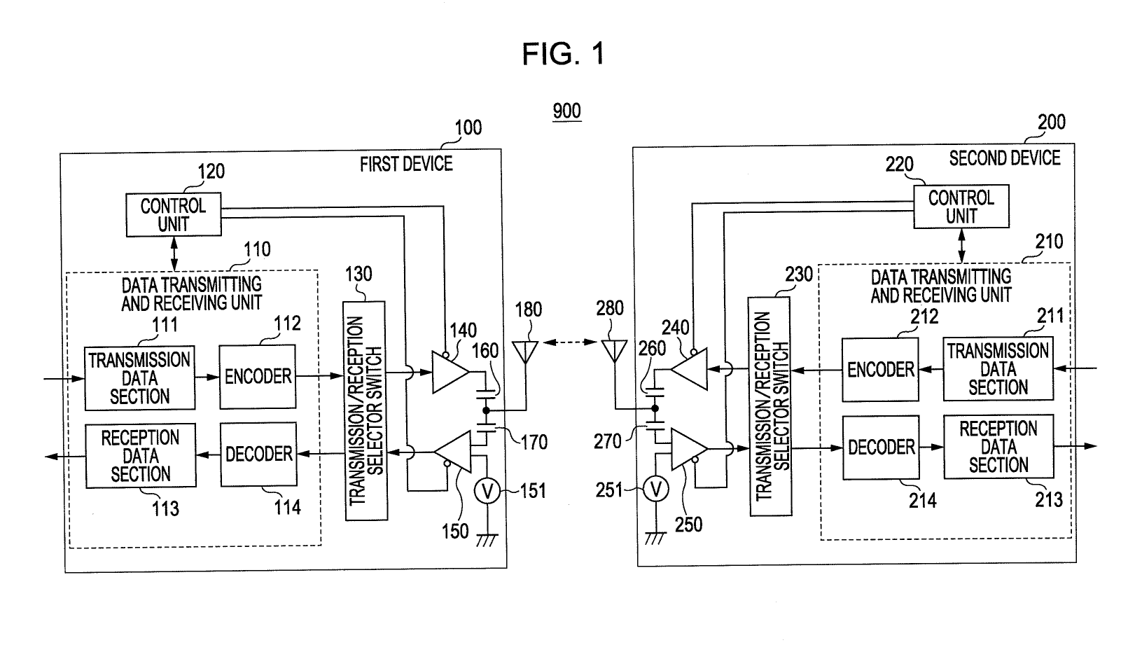

Embodiments of the present invention will be described with reference to FIGS. 1 to 20 in the following order.

1. Exemplary Internal Configuration of Communication System of First Embodiment (FIG. 1)

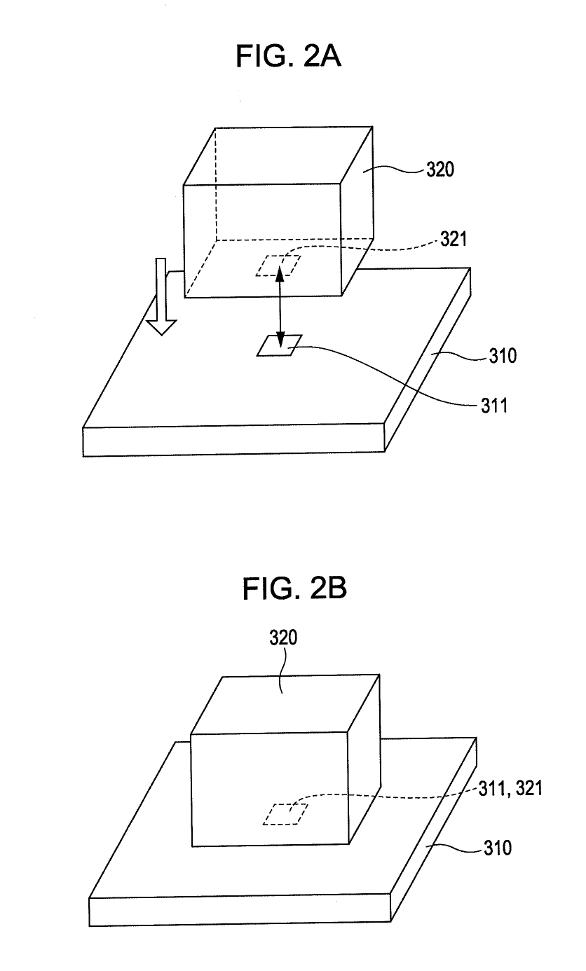

2. Exemplary Modules in Applications of Communication System of First Embodiment (FIGS. 2A to 5B)

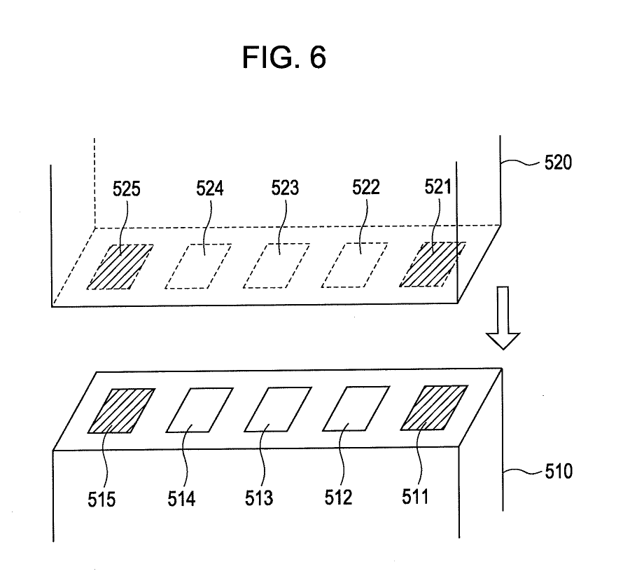

3. Exemplary Arrangements of Planar Antennas in Applications of Communication System of First Embodiment (FIGS. 6 to 9)

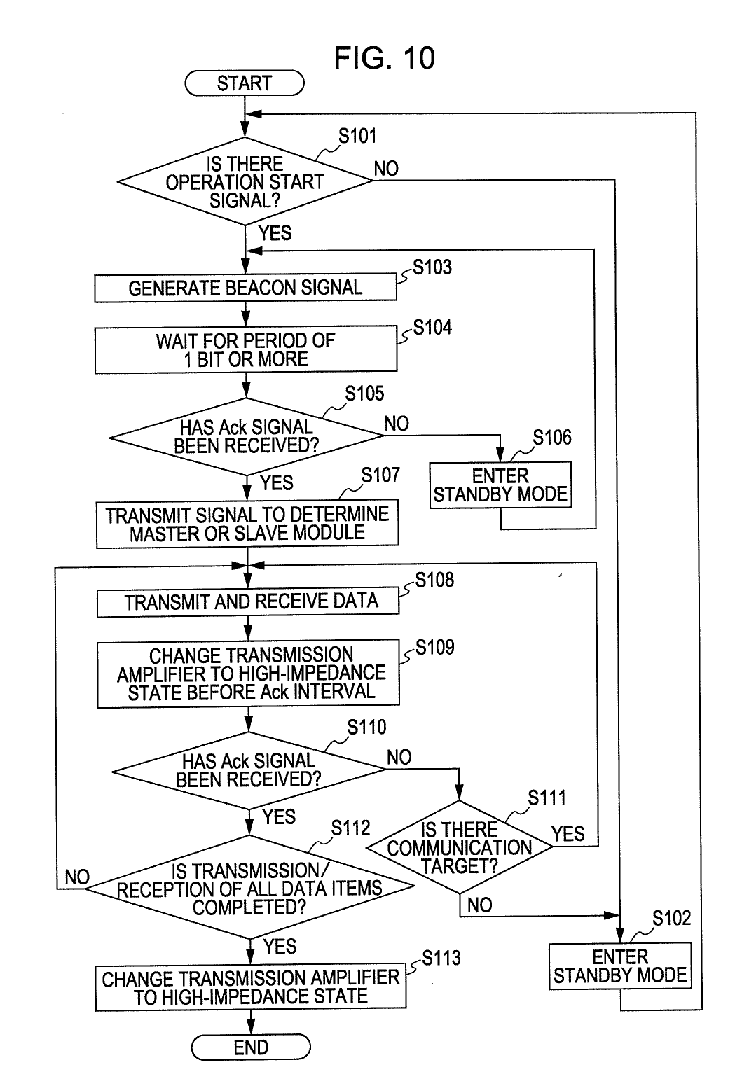

4. Exemplary Transmission Process of Communication System of First Embodiment (FIG. 10)

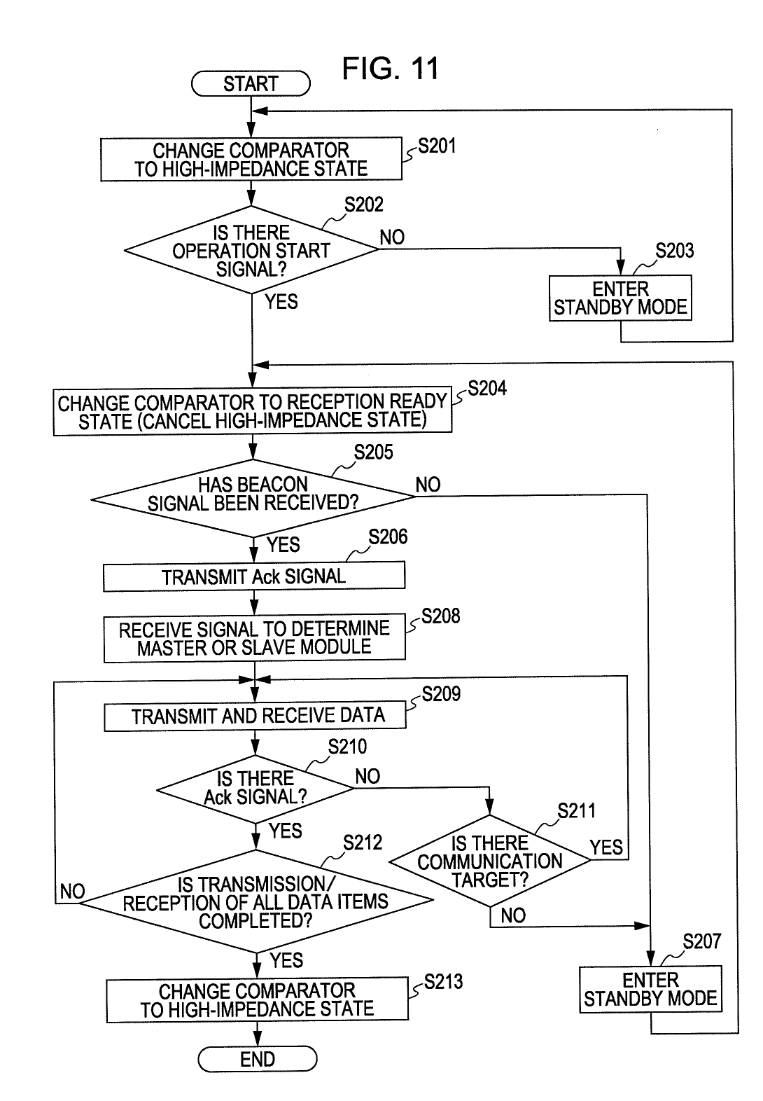

5. Exemplary Reception Process of Communication System of First Embodiment (FIG. 11)

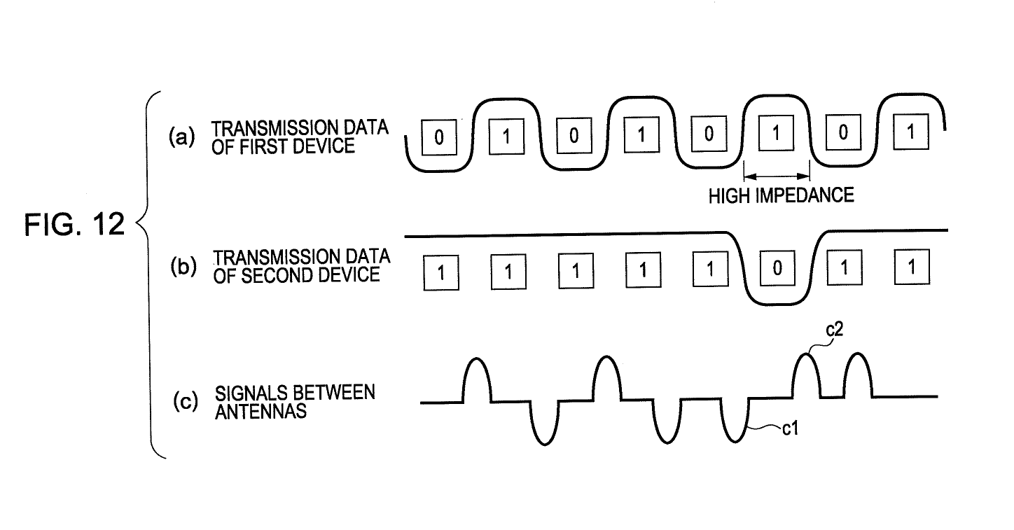

6. Exemplary States of Signals between Antennas in Communication System of First Embodiment (FIG. 12)

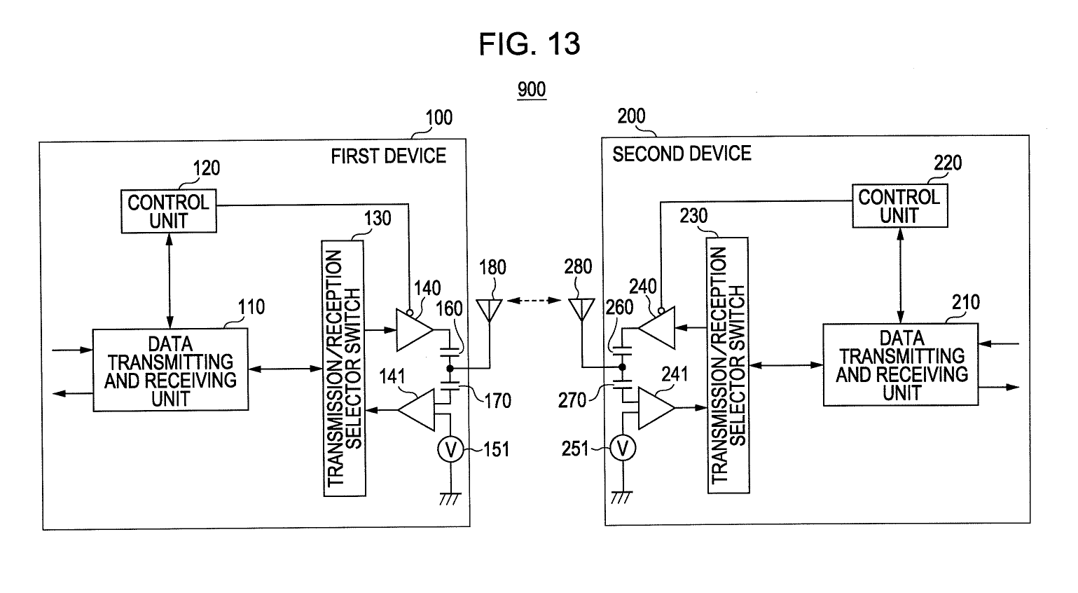

7. Modifications of First Embodiment (FIGS. 13 to 15)

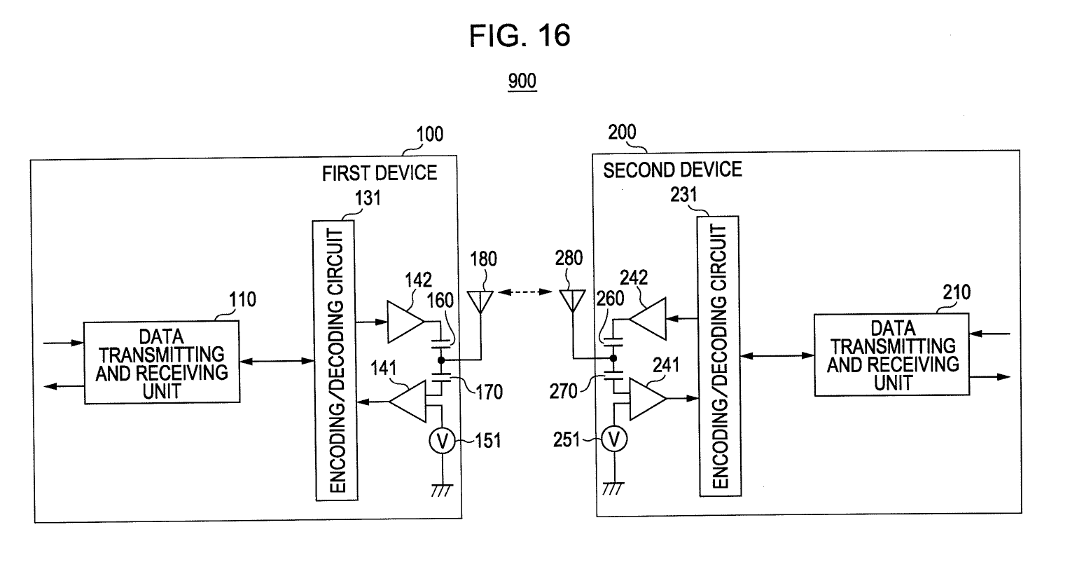

8. Exemplary Internal Configuration of Communication System of Second Embodiment (FIG. 16)

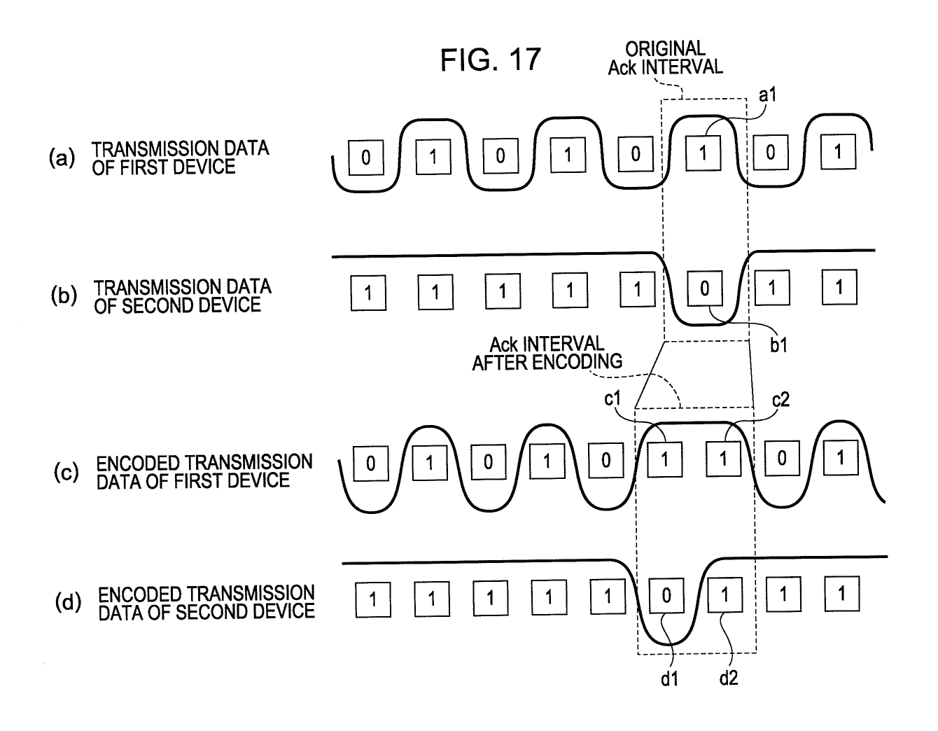

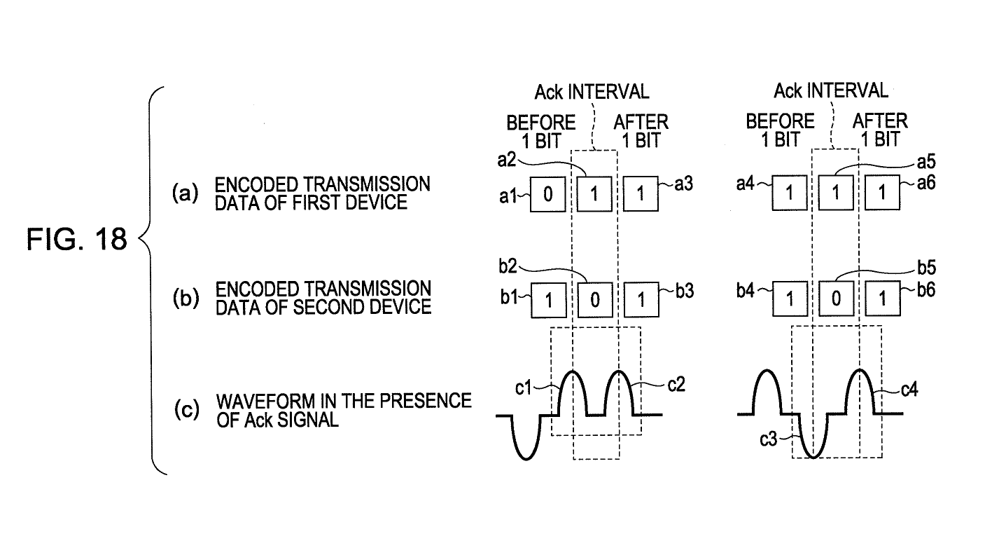

9. Exemplary States of Signals between Antennas in Communication System of Second Embodiment (FIGS. 17 and 18)

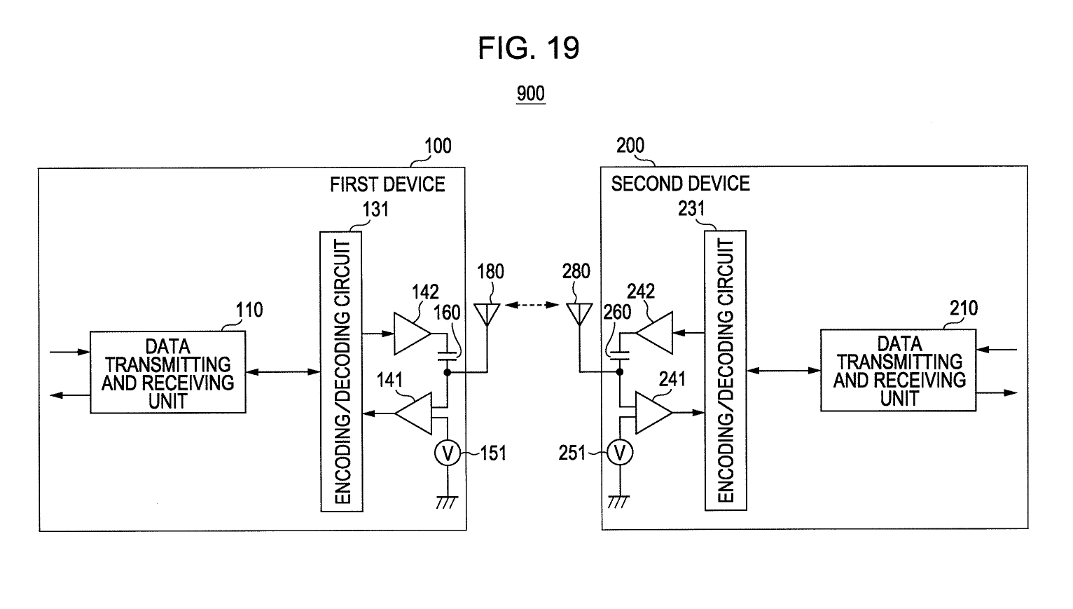

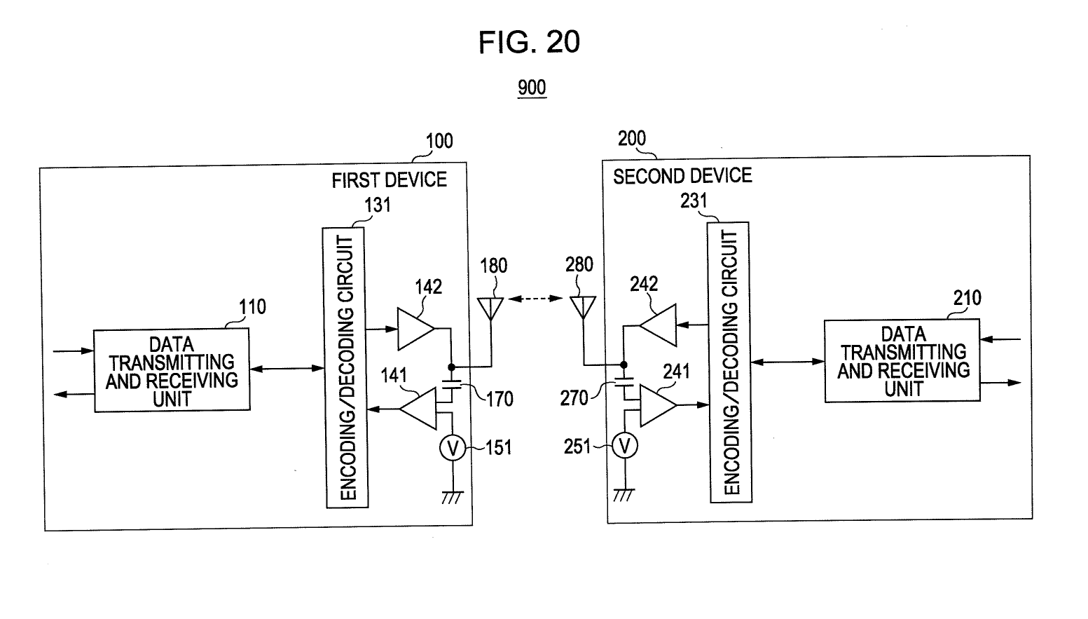

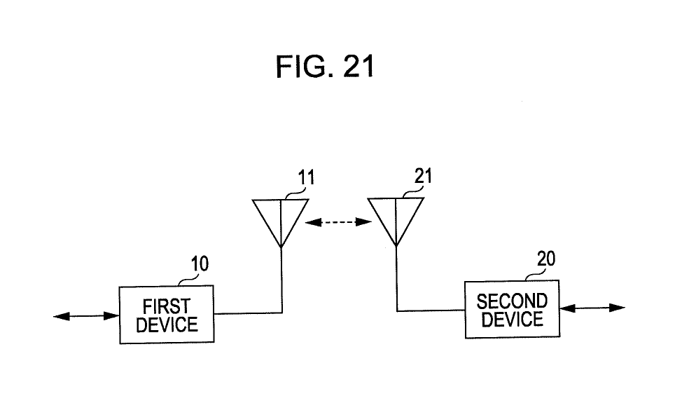

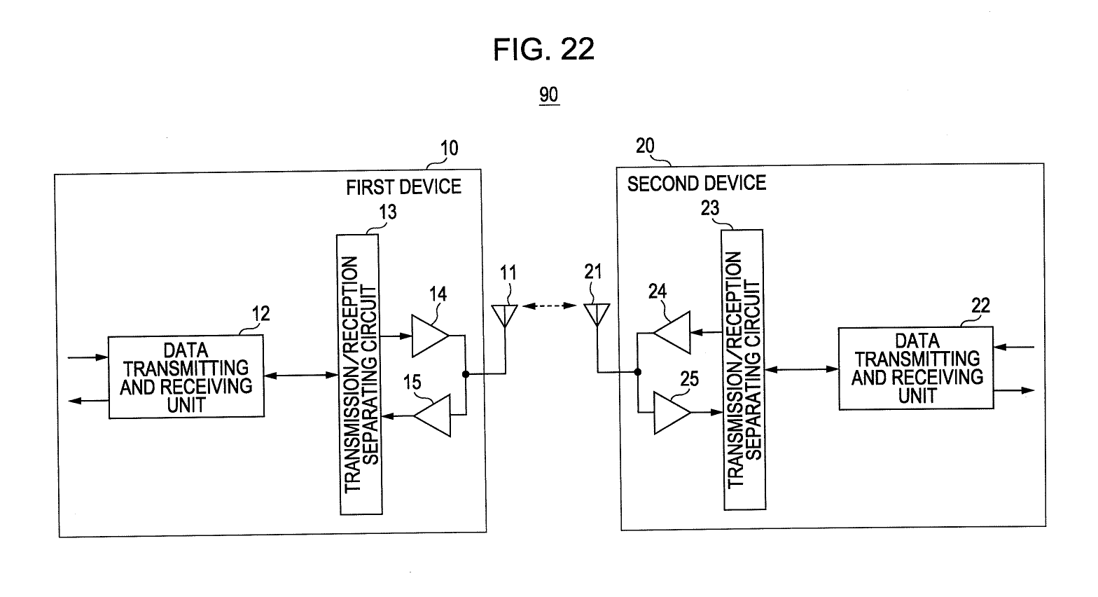

10. Modifications of Second Embodiment (FIGS. 19 and 20)

### 1. Exemplary Internal Configuration of Communication System

An exemplary internal configuration of a communication system according to a first embodiment of the present invention will be described below with reference to FIG. 1.

Referring to FIG. 1, the communication system, designated at 900, according to the present embodiment performs near field communication using not carrier waves but pulses. The communication system 900 includes a first device 100 including a transmission/reception antenna 180 and a second device 200 including a transmission/reception antenna 280.

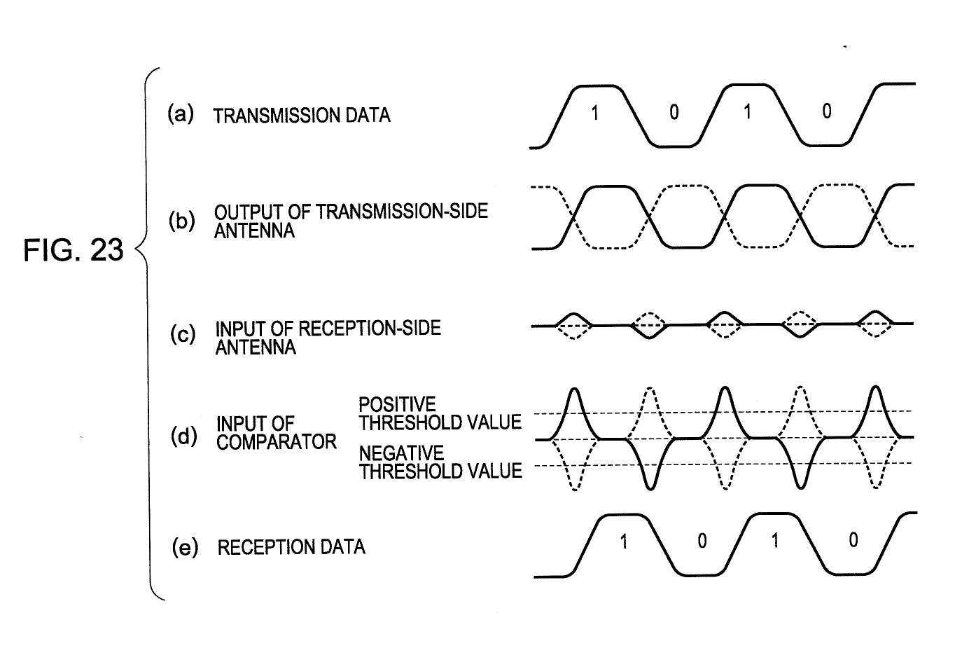

States of signals for wireless communication through pulses without using carrier waves are as described in “Description of the Related Art” with reference to FIG. 23. The transmission-side antenna outputs binary transmission data at a high level or a low level as it is. The reception-side antenna, located close to the transmission-side antenna, receives the transmission data. The reception-side antenna detects the transmitted signal as a differential signal indicating a change in the signal.

The transmission/reception antennas 180 and 280 perform two-way communication of 1-bit digital signals, serving as the above-described binary signals, between the first device 100 and the second device 200. The transmission/reception antennas 180 and 280 each include a planar antenna. These antennas are arranged such that the antennas face each other at a short distance for two-way communication.

The configuration of the first device 100 will now be described. The first device 100 includes a data transmitting and receiving unit 110. The data transmitting and receiving unit 110 is a processor for processing transmission data and also processing reception data. For example, the data transmitting and receiving unit 110 encodes data to be transmitted, decodes encoded data upon receiving the data, and analyzes received data. The data transmitting and receiving unit 110 is connected to a data processing unit (not illustrated) in the first device 100.

The data transmitting and receiving unit 110 includes a transmission data section 111 and an encoder 112. The transmission data section 111 is supplied with a signal to be transmitted and converts the signal into a transmission format. The encoder 112 encodes the transmission-formatted signal for transmission. The data transmitting and receiving unit 110 outputs the encoded transmission signal to a transmission/reception selector switch 130.

The transmission signal output from the data transmitting and receiving unit 110 is supplied through the transmission/reception selector switch 130 to a transmission amplifier 140. The transmission amplifier 140 is designed as a three-state amplifier. The three-state amplifier operates as follows. In a normal amplifying operation mode, when an input transmission signal is at a high level, namely, data “1”, the signal is amplified as data “1” and is then output. Alternatively, when the input transmission signal is at a low level, namely, data “0”, the signal is amplified as data “0” and is then output. In another mode different from the normal amplifying operation mode, an output of the three-state amplifier can be set to a high-impedance state. The transmission amplifier 140 functions as a three-state amplifier having the output state for data “1”, that for data “0”, and the high-impedance state. The operation for setting an output to the high-impedance state is set in accordance with a control signal supplied from a control unit 120, which will be described later.

An output of the transmission amplifier 140 is supplied through a capacitor 160 to the transmission/reception antenna 180 and is then wirelessly transmitted from the first device 100.

A process for a signal received by the transmission/reception antenna 180 will now be described.

The transmission/reception antenna 180 is connected through a capacitor 170 to a comparator 150. The comparator 150 sets comparison threshold values (i.e., a positive threshold value and a negative threshold value) on the basis of a reference potential supplied from a reference potential generator 151. The comparator 150 compares the level of a signal supplied from the transmission/reception antenna 180 with each of the positive and negative threshold values. The comparing operation is as described with reference to part (d) of FIG. 23. Note that the level of a received signal supplied to the comparator 150 is controlled by an automatic gain control (AGC) circuit (not illustrated) so that the level lies within a predetermined range and the signal subjected to level control is compared with each of the positive and negative threshold values.

The comparator 150 is designed as, for example, a hysteresis comparator. When the level of a received signal is at or above the positive threshold value, the comparator 150 maintains the output of data “1” at the high level. When the level thereof is at or below the negative threshold value, the comparator 150 maintains the output of data 0” at the low level. The operation of the comparator 150 is as described with reference to part (e) of FIG. 23.

The comparator 150 according to the present embodiment is capable of setting an input (at the connection node with a capacitor 170) for a received signal to the high-impedance state. Specifically, in a normal mode, the comparator 150 compares the level of an input signal with each of the positive and negative threshold values. When receiving a high-impedance state instruction, the comparator 150 sets an input to the high-impedance state and stops the comparing operation. Control for the high-impedance state is based on a control signal supplied from the control unit 120.

Data “1” or data “0” output from the comparator 150 is supplied through the transmission/reception selector switch 130 to the data transmitting and receiving unit 110. The data transmitting and receiving unit 110 further includes a decoder 114 and a reception data section 113. The decoder 114 performs decoding for reception on the received data and supplies the decoded reception data to the reception data section 113. The reception data section 113 processes the data to obtain reception data. The obtained reception data is supplied to the data processing unit (not illustrated) in the first device 100.

The control unit 120 controls the transmission process and the reception process in the data transmitting and receiving unit 110 and also controls the high-impedance state of the transmission amplifier 140 and that of the comparator 150. Control processing for the high-impedance state will be described in detail later when describing flowcharts of FIGS. 10 and 11.

The second device 200 which performs wireless communication with the first device 100 will now be described. The second device 200 has the same configuration for wireless communication as that of the first device 100. Specifically, the device 200 includes a data transmitting and receiving unit 210, a control unit 220, a transmission/reception selector switch 230, a transmission amplifier 240, a comparator 250, a reference potential generator 251, a capacitor 260, and a capacitor 270. In FIG. 1, as for the components of the first and second devices 100 and 200, the reference numerals indicating the same component have the same last two digits. The second device 200 has the exactly same mechanism for processing a transmission signal and a received signal as that of the first device 100. Accordingly, detailed description of the components of the second device 200 is omitted.

### 2. Exemplary Modules in Applications of Communication System of First Embodiment

Exemplary configurations of modules in applications of the communication system 900 according to the present embodiment will be described with reference to FIGS. 2A to 5B. In FIGS. 2A to 5B, the first device and the second device are illustrated as a master module and a slave module, respectively. The master module includes a wireless communication unit that serves as the first device 100 in FIG. 1 and the slave module includes a wireless communication unit that serves as the second device 200.

FIGS. 2A and 2B each illustrate the master module, indicated at 310, and the slave module, indicated at 320, mounted with planar antennas 311 and 321, respectively. The planar antennas 311 and 321 correspond to the transmission/reception antennas 180 and 280 in FIG. 1, respectively.

FIG. 2A illustrates the modules 310 and 320 before connection (i.e., separated from each other). FIG. 2B illustrates the modules 310 and 320 placed close to each other and wirelessly connected to each other. The planar antenna 311 placed in a predetermined position on one surface of the master module 310 is allowed to face the planar antenna 321 placed in a predetermined position on one surface of the slave module 320, as illustrated in FIG. 2A. In this state, the planar antennas 311 and 321 are brought close to each other so as to be come into contact with each other, as illustrated in FIG. 2B. Although the modules are illustrated as being in contact with each other in FIG. 2B, the modules are actually arranged such that the planar antennas 311 and 321 are spaced from each other at a small distance of approximately 1 mm or less in order to prevent conductors of the antennas from being in contact with each other while the modules are placed close to each other.

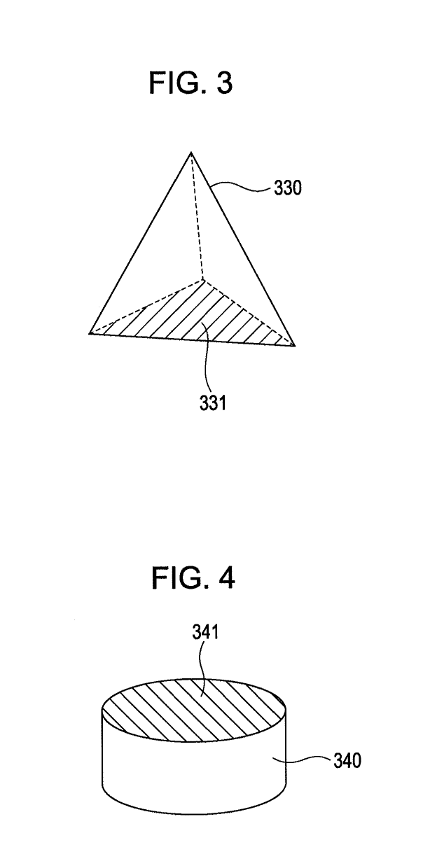

FIGS. 3 and 4 are perspective views of other slave modules in other forms. FIG. 3 illustrates a slave module 330 shaped in a triangular pyramid. The bottom surface of the slave module is an antenna mounting surface 331 on which the planar antenna is mounted. FIG. 4 illustrates a slave module 340 shaped in a cylinder. The upper end surface of the slave module 340 is an antenna mounting surface 341 on which the planar antenna is mounted. The antenna mounting surfaces 331 and 341 each serve as a portion where the transmission/reception antenna 280 is mounted. The transmission/reception antenna 280 is mounted at, for example, substantially the center of the antenna mounting surface of each slave module.

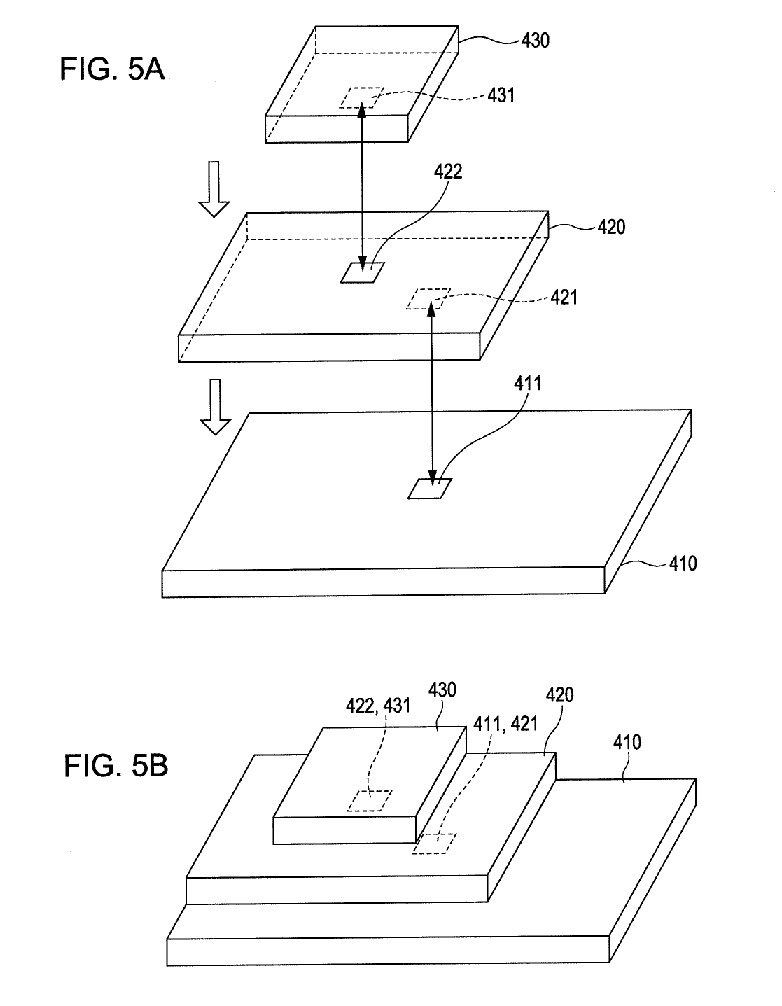

FIGS. 5A and 5B each illustrate arrangement of three modules. In this arrangement, two slave modules are placed.

Referring to FIG. 5A, a master module 410, a first slave module 420, and a second slave module 430 are arranged. The master module 410 is mounted with a planar antenna 411 in a predetermined position on the upper surface thereof. The first slave module 420 is mounted with a planar antenna 421 in a predetermined position on the lower surface thereof and is further mounted with a planar antenna 422 in a predetermined position on the upper surface thereof. The second slave module 430 is mounted with a planar antenna 431 in a predetermined position on the lower surface thereof. The first slave module 420 includes two communication processing units, i.e., a wireless communication processing unit for wireless communication with the master module 410 and a wireless communication processing unit for wireless communication with the second slave module 430.

As indicated by arrows in FIG. 5A, the first slave module 420 is placed on the master module 410 and the second slave module 430 is placed on the first slave module 420, so that the modules are placed on one another as illustrated in FIG. 5B. In this state illustrated in FIG. 5B, the first slave module 420 is placed on the master module 410 such that the planar antenna 421 faces the planar antenna 411 of the master module 410. Furthermore, the second slave module 430 is placed on the first slave module 420 such that the planar antenna 422 faces the planar antenna 431. Consequently, the master module 410 is wirelessly connected to the first slave module 420 and the first slave module 420 is wirelessly connected to the second slave module 430.

As described above, the communication system 900 can be constructed using modules with various forms. For convenience of explanation, one of the modules is the master module and the other module (or modules) is the slave module in FIGS. 2A, 2B, 5A, and 5B. Any of the modules may be the master module or the slave module.

### 3. Exemplary Arrangements of Planar Antennas in Applications of Communication System of First Embodiment

Exemplary arrangements of planar antennas on predetermined surfaces of the master and slave modules will be described as applications of the communication system 900 according to the present embodiment with reference to FIGS. 6 to 9.

A plurality of planar antennas are configured to individually perform wireless communication. For example, three combinations of antennas are provided to simultaneously transmit different data items of three systems.

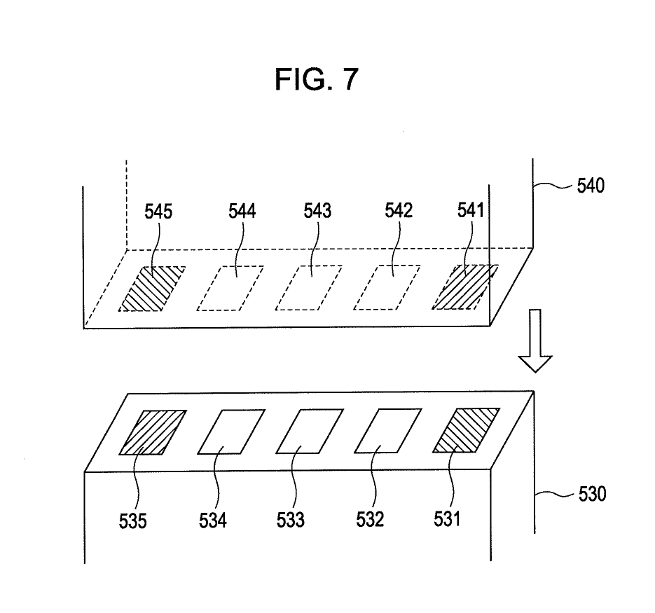

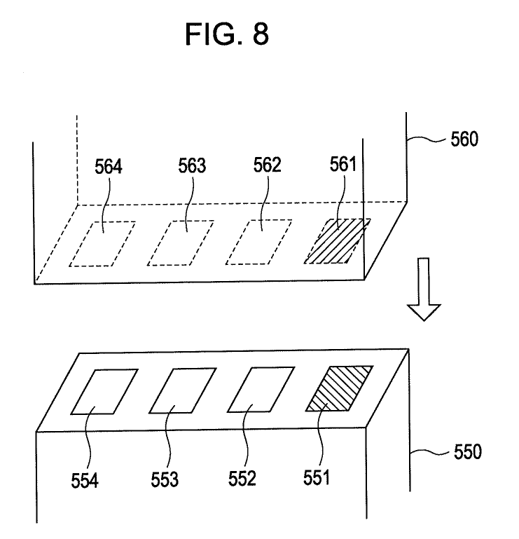

In this arrangement of antennas, each antenna has to exactly face the corresponding antenna. In FIG. 6, therefore, antennas are arranged in a row on each module and magnets are further placed close to the row of antennas so that the two modules are accurately positioned and come into contact with each other by magnetic forces. FIGS. 7 and 8 each illustrate an arrangement in which a magnet is provided for one module and a magnetic sensor for detecting a magnetic force of the magnet is provided for the other module so that the modules can be positioned.

The arrangements of planar antennas will be sequentially described below.

FIG. 6 illustrates the arrangement in which planar antennas and magnets are arranged on each of the surface of a master module 510 and that of a slave module 520, the surfaces of the modules facing each other. On the predetermined surface of the master module 510, a magnet 511, a planar antenna 512, a planar antenna 513, a planar antenna 514, and a magnet 515 are arranged in a straight line in order from the right. On the surface of the slave module 520 facing the master module 510, a magnet 521, a planar antenna 522, a planar antenna 523, a planar antenna 524, and a magnet 525 are arranged in a straight line in order from the right. The two modules 510 and 520 have the same spacing between the components.

With this arrangement, the magnets are arranged on both the ends of the surface of each of the master module 510 and the slave module 520. Thus, the master module 510 and the slave module 520 attract each other by magnetic forces. In other words, the combination of the planar antennas 512 and 522, the combination of the planar antennas 513 and 523, and the combination of the planar antennas 514 and 524 can be more accurately positioned. Although the above positioning is performed using the magnets, a mechanical mechanism may be used for positioning without using magnets. For example, a screw or lock mechanism may be provided.

In this arrangement, two magnets are provided for each module. One magnet or three or more magnets may be provided. When a plurality of magnets are used, the modules can be fixed more strongly.

FIG. 7 illustrates an arrangement in which a plurality of planar antennas, a magnet, and a magnetic sensor are arranged on each of the surface of a master module 530 and that of a slave module 540, the surfaces of the modules facing each other. On the predetermined surface of the master module 530, a magnetic sensor 531, a planar antenna 532, a planar antenna 533, a planar antenna 534, and a magnet 535 are arranged in a straight line in order from the right. On the surface of the slave module 540 facing the master module 530, a magnet 541, a planar antenna 542, a planar antenna 543, a planar antenna 544, and a magnet 545 are arranged in a straight line in order from the right. In this case, the magnetic sensors and the magnets are used to measure the distance between the master module 530 and the slave module 540. Accordingly, whether the master module 540 and the slave module 530 are placed close to each other so that the modules can perform wireless communication with each other can be determined. Using a signal indicating the result of determination, a power supply for the slave module can be controlled, alternatively, transmission/reception of radio signals can be controlled. As for a combination of the magnet and the magnetic sensor, two combinations are used in this arrangement illustrated in FIG. 7. One combination or three or more combinations may be used. If a plurality of combinations are arranged, the antennas can be positioned more accurately. In this case, some of the magnets may be positioned such that the magnets of one module attract those of the other module, as illustrated in FIG. 6.

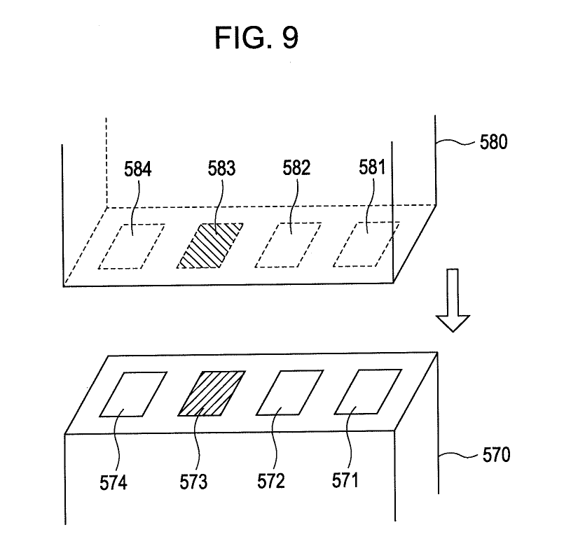

FIGS. 8 and 9 illustrate modifications of the arrangement of FIG. 7.

FIG. 8 illustrates an arrangement in which a plurality of planar antennas, a magnet, and a magnetic sensor are arranged on the opposed surfaces of a master module 550 and a slave module 560. On the predetermined surface of the master module 550, a magnetic sensor 551, a planar antenna 552, a planar antenna 553, and a planar antenna 554 are arranged in a straight line in order from the right. On the surface of the slave module 560 facing the master module 550, a magnet 561, a planar antenna 562, a planar antenna 563, and a planar antenna 564 are arranged in a straight line in order from the right.

FIG. 9 illustrates an arrangement in which a plurality of planar antennas, a magnet, and a magnetic sensor are arranged on the opposed surfaces of a master module 570 and a slave module 580. On the predetermined surface of the master module 570, a planar antenna 571, a planar antenna 572, a magnet 573, and a planar antenna 574 are arranged in a straight line in order from the right. On the surface of the slave module 580 facing the master module 570, a planar antenna 581, a planar antenna 582, a magnetic sensor 583, and a planar antenna 584 are arranged in a straight line in order from the right.

The arrangements illustrated in FIGS. 8 and 9 also obtain the same advantages as those of the arrangement in FIG. 7.

In the arrangements in FIGS. 6 to 9, three planar antennas are provided for each module. Since an interface such as Serial Peripheral Interface (SPI) uses three lines, the three antennas are provided for each module. As for Inter-Integrated Circuit (I²C) interface, since the I²C interface uses two lines, a serial clock line (SCL) and a serial data line (SDA), two antennas are provided for each module. The SCL is used for synchronization. The SDA is used for transmission of a bidirectional signal whose directions of input and output change depending on transmission/reception. In the I²C interface, three antennas may be provided for each module so that communication through the SCL and SDA lines and power transmission are performed. Specifically, although FIGS. 6 to 9 each illustrate the arrangement in which three antennas are provided for each module, N antennas are arranged in the use of N signal lines for communication (N is a natural number).

### 4. Exemplary Transmission Process of Communication System of First Embodiment

A transmission process of the communication system 900 according to the first embodiment will now be described with reference to a flowchart of FIG. 10. This process is performed when the first device 100 and the second device 200 illustrated in FIG. 1 are placed very close to each other while the devices facing each other. The process depicted in the flowchart of FIG. 10 is performed in the first device 100 under the control of the control unit 120.

First, the control unit 120 determines whether there is an operation start signal (step S101). This operation start signal is generated by a unit for detecting face-to-face near field placement of the transmission/reception antennas 180 and 280. For example, the magnetic sensor 531 provided for the one module illustrated in FIG. 7 is used as the unit for detecting the approach of the magnet 541 provided for the other module. The operation start signal may be generated independently of an approach detection signal.

If there is no operation start signal, the control unit 120 temporarily enters a standby mode (step S102). The control unit 120 returns to step S101 and determines whether there is an operation start signal.

When it is determined in step S101 that there is an operation start signal, a beacon signal is output as transmission data to be transmitted from a transmitting circuit (step S103). After that, the control unit 120 waits for a predetermined of period of 1 bit or more (step S104).

After waiting, the control unit 120 determines whether an Ack signal has been received by a receiving circuit (step S105). The Ack signal is a reception confirmation response signal indicating that transmission data has been correctly received by a communication target. The Ack signal has a predetermined pattern. If the Ack signal has not been received, the control unit 120 temporarily enters the standby mode (step S106) and returns to step S103. A beacon signal is again generated.

If the Ack signal has been received, a signal to determine the master or slave module is transmitted under the control of the control unit 120 (step S107). After that, transmission/reception of actual data is performed between the first device 100 and the second device 200 (step S108).

Just before an interval during which the Ack signal is received, the control unit 120 changes the transmission amplifier 140, illustrated in FIG. 1, from the normal state to the high-impedance state (step S109). The change to the high-impedance state is temporary. The transmission amplifier 140 is immediately returned to the original normal state at the time when it seems that the reception of the Ack signal is completed. For example, when the Ack signal is a 1-bit signal, the transmission amplifier 140 is held in the high-impedance state only for a period of time during which the 1-bit signal is received.

The control unit 120 then determines whether an Ack signal has been received by the receiving circuit (step S110). If the Ack signal has not been received, the control unit 120 determines whether there is a communication target (step S111). When it is determined that there is no communication target, the control unit 120 temporarily enters the standby mode (step S102) and again determines whether there is an operation start signal (step S101). If there is a communication target, the control unit 120 returns to step S108 and continues the transmission/reception of data.

If it is determined in step S110 that the Ack signal has been received, the control unit 120 determines whether the transmission/reception of all data items is completed (step S112). If the transmission/reception of all data items is not completed, the control unit 120 continuously performs the transmission/reception of data (step S108). If the transmission/reception of all data items is completed, the control unit 120 changes the transmission amplifier 140, illustrated in FIG. 1, from the normal state to the high-impedance state (step S113) and terminates the transmission process.

### 5. Exemplary Reception Process of Communication System of First Embodiment

A reception process of the communication system 900 according to the first embodiment will now be described with reference to FIG. 11. This process is performed when the first device 100 and the second device 200 illustrated in FIG. 1 are placed very close to each other at a short distance such that the first device 100 and the second device 200 face each other. The process depicted in a flowchart of FIG. 11 is performed by the first device 100 under the control of the control unit 120.

First, an input of the comparator 150 included in the receiving circuit is changed to the high-impedance state under the control of the control unit 120 (step S201). The control unit 120 determines whether there is an operation start signal (step S202). The determination as to whether there is an operation start signal is the same as that in step S101 of the flowchart of FIG. 10. The operation start signal is based on detection of the presence of a nearby placed device, serving as a communication target.

If the control unit 120 does not detect an operation start signal, the control unit 120 temporarily enters the standby mode (step S203). After that, the control unit 120 returns to step S201 and changes an input of the comparator 150 to the high-impedance state.

If the control unit 120 detects an operation start signal, the control unit 120 cancels the high-impedance state of the comparator 150 to change the comparator 150 to the normal state so that the comparator 150 is ready to receive a beacon signal (step S204). Such a normal state is also called “(beacon) reception ready state”. The control unit 120 determines whether a beacon signal generated from the opposed device has been received (step S205). If the reception of a beacon signal is not detected, the control unit 120 temporarily enters the standby mode (step S207). The control unit 120 again returns to step S204 and allows the comparator 150 to enter the beacon reception ready state.

If the beacon signal has been received, an Ack signal is transmitted by the transmitting circuit to the beacon transmission source (step S206).

After that, a signal, transmitted from the beacon transmission source, to determine the master or slave module is received (step S208). Transmission/reception of actual data is performed between the first device 100 and the second device 200 (step S209).

The control unit 120 determines whether there is an Ack signal to be transmitted to the beacon transmission source (step S210). If there is no Ack signal, the control unit 120 determines whether the device, serving as a communication target, is placed nearby (step S211). If there is no device serving as the beacon transmission source, the control unit 120 returns to step S207. The control unit 120 temporarily enters the standby mode and then allows the comparator 150 to enter the reception ready state in step S204. If the device serving as the communication target is placed nearby, the control unit 120 returns to step S209 and continues the transmission/reception of data.

If it is determined in step S210 that there is an Ack signal, the control unit 120 determines whether the transmission/reception of all data items is completed (step S212). If the transmission/reception of all data items is not completed, the control unit 120 continuously performs the transmission/reception of data in step S209. If the transmission/reception of all data items is completed, the control unit 120 changes the input terminal of the comparator 150 to the high-impedance state (step S213) and terminates the reception process.

### 6. Exemplary States of Signals Between Antennas in Communication System of First Embodiment

The states of signals wirelessly transmitted between the transmission/reception antenna 180 of the first device 100 and the transmission/reception antenna 280 of the second device 200 in the above-described communication processing conditions will now be described with reference to FIG. 12.

In the first device 100, it is assumed that transmission data output from the encoder 112 includes data “1” and data “0” which appear alternately, as illustrated in part (a) of FIG. 12. In the second device 200, it is assumed that an Ack signal, serving as data “0”, is output from the encoder 212 and is then transmitted for a 1-bit interval at specific timing of transmission data of the device 200, as illustrated in part (b) of FIG. 12. In the second device 200, a state in which data “1” is transmitted is continued, except for the interval during which the Ack signal is transmitted.

Part (c) of FIG. 12 illustrates the waveform of signals wirelessly transmitted between the antennas 180 and 280 on the above-described conditions. The comparator 150 or 250 connected to the reception-side antenna detects levels corresponding to the waveform.

In the present embodiment, as described with reference to the flowchart of FIG. 10, an output of the transmission amplifier 140 in the first device 100 is in the high-impedance state for an interval during which an Ack signal is transmitted from the transmission/reception antenna 280 of the second device 200. Accordingly, the comparator 150 connected to the transmission/reception antenna 180 of the first device 100 is not affected by transmission data transmitted from the first device 100. Consequently, the comparator 150 can correctly detect waveform segments c1 and c2 (refer to part (c) of FIG. 12) necessary for detection of the Ack signal, serving as data “0”, so that the Ack signal as reception confirmation response can be correctly received.

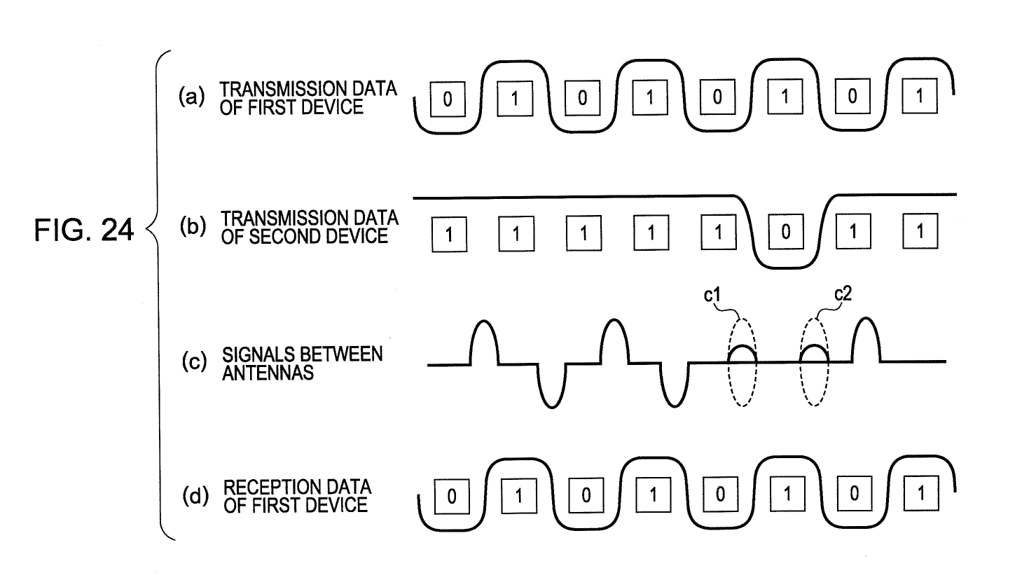

In the present embodiment, as illustrated in FIG. 1, the capacitor is connected between the transmission amplifier 140 and the transmission/reception antenna 180 in the first device 100, the capacitor is connected between the transmission amplifier 240 and the transmission/reception antenna 280 in the second device 200, the capacitor is connected between the comparator 150 and the transmission/reception antenna 180, and the capacitor is connected between the comparator 250 and the transmission/reception antenna 280. Accordingly, measure against high frequency is taken, so that differential signals of the signals wirelessly transmitted between the antennas 180 and 280 can be properly detected. Thus, two-way wireless communication can be properly performed using both of the measure taken by the capacitors and the process for the high-impedance state. In the related art, an Ack signal may not be received as described with reference to FIG. 24. According to the present embodiment, such a problem can be avoided.

Therefore, providing a pair of antennas for the devices 100 and 200 allows two-way wireless communication, thus reducing antenna mounting space.

### 7. Modifications of First Embodiment

Modifications of the devices included in the communication system according to the first embodiment will be described below with reference to FIGS. 13 to 15.

In FIGS. 13 to 15, the connection to the antennas 180 and 280 of the system illustrated in FIG. 1 is modified.

The modification of FIG. 13 will be described. The system in FIG. 1 includes the three-state comparators 150 and 250 in the receiving circuits of the devices 100 and 200 so that an input of each comparator can be set to the high-impedance state. On the other hand, the system in FIG. 13 includes comparators 141 and 241 which are of a normal type and whose input is not set to the high-impedance state.

As for the transmission amplifiers 140 and 240, the amplifiers of the type which can be set to the high-impedance state are used. The control units 120 and 220 each perform the control processing depicted in the flowchart of FIG. 10. Outputs of the transmission amplifiers 140 and 240 are connected through the capacitors 160 and 260 to the transmission/reception antennas 180 and 280, respectively, as illustrated in FIG. 13.

The capacitor 170 is connected between the transmission/reception antenna 180 and the comparator 141 and the capacitor 270 is connected between the transmission/reception antenna 280 and the comparator 241, as illustrated in FIG. 13.

The configuration of each of the data transmitting and receiving units 110 and 210 is the same as that in FIG. 1.

The configuration of the system illustrated in FIG. 13 also allows two-way wireless communication between the devices 100 and 200.

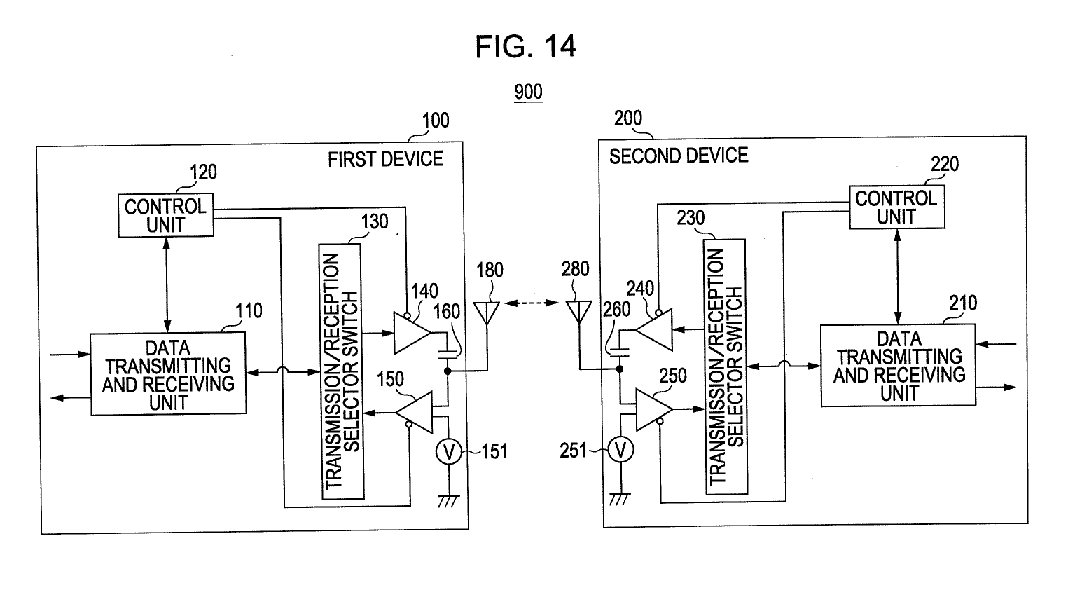

The modification of FIG. 14 will be described.

In the modification of FIG. 14, the capacitors 170 and 270 included in the receiving circuits in FIG. 1 are omitted. Specifically, as illustrated in FIG. 14, outputs of the transmission amplifiers 140 and 240 are connected through the capacitors 160 and 260 to the transmission/reception antennas 180 and 280, respectively. On the other hand, the transmission/reception antennas 180 and 280 are directly connected to the comparators 150 and 250 without capacitors, respectively. The comparators 150 and 250 are of the three-state type. The normal type of comparators which are not set to the high-impedance state may be used.

The other components are the same as those in FIG. 1.

The configuration of the system illustrated in FIG. 14 allows two-way wireless communication between the devices 100 and 200.

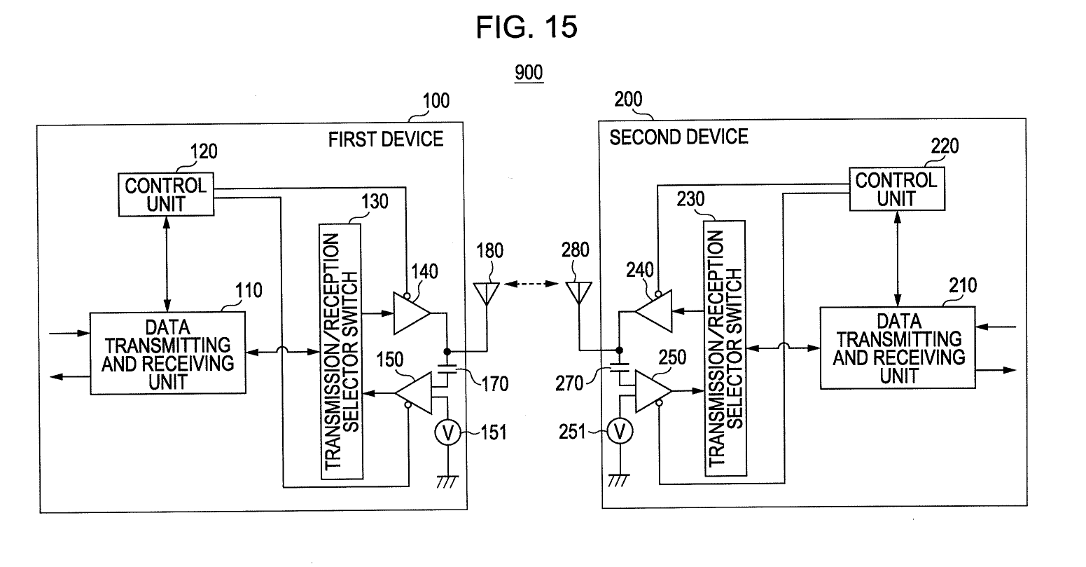

The modification of FIG. 15 will be described.

In the modification of FIG. 15, the capacitors 160 and 260 included in the transmitting circuits in the system of FIG. 1 are omitted. Specifically, as illustrated in FIG. 15, outputs of the three-state transmission amplifiers 140 and 240 are directly connected to the transmission/reception antennas 180 and 280, respectively. On the other hand, the transmission/reception antenna 180 is connected through the capacitor 170 to the comparator 150 and the transmission/reception antenna 280 is connected through the capacitor 270 to the comparator 250. The transmission amplifiers 140 and 240 and the comparators 150 and 250 are of the three-state type. The normal type components which are not set to the high-impedance state may be used.

The other components are the same as those in FIG. 1.

The configuration illustrated in FIG. 15 also allows two-way wireless communication between the devices 100 and 200.

### 8. Exemplary Internal Configuration of Communication System of Second Embodiment

A second embodiment of the present invention will now be described with reference to FIGS. 16 to 20. In FIGS. 16 to 20, components corresponding to those in FIGS. 1 to 15 described in the first embodiment are designated by the same reference numerals.

FIG. 16 illustrates the internal configuration of a communication system according to the present embodiment. The communication system, indicated at 900, according to the present embodiment illustrated in FIG. 16 performs near field communication using not carrier waves but pulses. This system includes a first device 100 including a transmission/reception antenna 180 and a second device 200 including a transmission/reception antenna 280.

The states of signals wirelessly communicated using not carrier waves but pulses are as described with reference to FIG. 23 in “Background of Related Art”. Binary transmission data at the high level or low level is output from the transmission-side antenna and is received by the reception-side antenna placed nearby. The reception-side antenna detects the transmitted signal as a differential signal indicating a change in the signal.

The transmission/reception antennas 180 and 280 perform two-way communication of digital signals, i.e., the above-described binary 1-bit signals, between the first device 100 and the second device 200. The transmission/reception antennas 180 and 280 each include a planar antenna. These antennas are arranged at a short distance so as to face each other, thus performing two-way communication.

The configuration of the first device 100 will now be described. The first device 100 includes a data transmitting and receiving unit 110. The data transmitting and receiving unit 110 is a processor for processing transmission data and also processing reception data. For example, the data transmitting and receiving unit 110 encodes data to be transmitted, decodes encoded data upon receiving the data, and analyzes received data. The data transmitting and receiving unit 110 is connected to a data processing unit (not illustrated) in the first device 100.

A transmission signal output from the data transmitting and receiving unit 110 is supplied through an encoding/decoding circuit 131 to a transmission amplifier 142. A process by the encoding/decoding circuit 131 will be described later. The transmission amplifier 142 amplifies the supplied signal for transmission. An output of the transmission amplifier 142 is supplied through a capacitor 160 to the transmission/reception antenna 180.

A signal obtained through the transmission/reception antenna 180 is supplied through a capacitor 170 to a comparator 141. The comparator 141 is configured to set comparison threshold values (a positive threshold value and a negative threshold value) on the basis of a reference potential supplied from a reference potential generator 151. The comparator 141 compares an input signal supplied from the transmission/reception antenna 180 with the positive and negative threshold values. The comparing operation is as described with reference to part (d) of FIG. 23. Note that the level of a received signal supplied to the comparator 141 is controlled by an automatic gain control (AGC) circuit (not illustrated) so that the level lies within a predetermined range and the signal subjected to level control is compared with each of the positive and negative threshold values.

The comparator 141 is designed as, for example, a hysteresis comparator. When the level of a received signal is at or above the positive threshold value, the comparator 141 maintains the output of data “1” at the high level. When the level thereof is at or below the negative threshold value, the comparator 150 maintains the output of data 0” at the low level. The operation of the comparator 141 is as described with reference to part (e) of FIG. 23.

The second device 200 which performs wireless communication with the first device 100 will now be described. The second device 200 has the same configuration for wireless communication as that of the first device 100. Specifically, the device 200 includes a data transmitting and receiving unit 210, a control unit 220, an encoding/decoding circuit 231, a transmission amplifier 242, a comparator 241, a reference potential generator 251, a capacitor 260, and a capacitor 270. In FIG. 16, as for the components of the first and second devices 100 and 200, the reference numerals indicating the same component have the same last two digits. The second device 200 has the exactly same mechanism for processing a transmission signal and a received signal as that of the first device 100. Accordingly, detailed description of the components of the second device 200 is omitted.

In the present embodiment of FIG. 16, the transmission amplifiers 142 and 242 and the comparators 141 and 241 are not of the three-state type. These components may be designed to be of the three-state type. In a normal transmission/reception state, it is unnecessary to perform a process for the high-impedance state.

States of data transmission in the system with the configuration in FIG. 16 will be described with reference to a timing diagram of FIG. 17.

As for encoding and decoding by the encoding/decoding circuits 131 and 231, according to the present embodiment, the device on the reception side of an Ack signal performs encoding such that specific data of 1 bit is added to transmission data at the time when the device receives the Ack signal. The device on the reception side of data transmitted from the device on the reception side of the Ack signal, namely, the device on the transmission side of the Ack signal performs decoding such that specific data of 1 bit is eliminated from a received signal.

Furthermore, in the device on the transmission side of the Ack signal, the encoding/decoding circuit 131 or 231 performs encoding so that the 1-bit Ack signal is transmitted at the time corresponding to the added specific 1-bit data. In the device on the reception side of the Ack signal, the encoding/decoding circuit 131 or 231 performs decoding so that received data is extracted at the time corresponding to the added specific 1-bit data.

The process by the encoding/decoding circuits 131 and 231 is mathematically expressed as follow.

To perform encoding/decoding, a bit rate r is increased by the following expression:

r=(N+1)/N*G

where N denotes the number of bits representing a word size to be transmitted or received and G denotes a band (bps) before transmission or reception.

Encoding in the device on the transmission side of data is expressed as (transmission bit string)+(1-bit interval for waiting for Ack signal)+(1 bit).

As for encoding in the device on the reception side of data, the Ack signal is output for 1 bit, serving as an interval for waiting for the Ack signal.

As for decoding, a signal corresponding to the 1-bit interval added upon encoding is eliminated. Determination on the transmitted signal is performed in the same manner as that before encoding.

Furthermore, so long as a pulse is generated for a 1-bit interval following that for waiting for the Ack signal and the preceding bit is the same as that on the transmission side, it is determined that the Ack signal has been transmitted.

9. Exemplary States of Signals between Antennas in Communication System of Second Embodiment

The timing diagram of FIG. 17 will be described on the assumption that the above-described processes are performed. Parts (a) and (b) of FIG. 17 illustrate transmission data items output from the data transmitting and receiving units 12 and 22 of the first and second devices, respectively. Parts (c) and (d) of FIG. 17 illustrate transmission data items encoded and output from the encoding/decoding circuits 131 and 231 of the first and second devices, respectively.

Referring to part (c) of FIG. 17, the encoded transmission data of the first device includes data items c1 and c2 of two bits corresponding to 1-bit data al (refer to part (a) of FIG. 17) for the Ack interval before encoding. The data items c1 and c2 of two bits are obtained by repeating the 1-bit data al before encoding two times (corresponding to two bits).

Referring to part (d) of FIG. 17, the encoded transmission data of the second device includes data items d1 and d2 of two bits corresponding to 1-bit data b1 (refer to part (b) of FIG. 17) for the Ack interval before encoding. The data d1 is the same as the 1-bit data b1 for the Ack interval before encoding and the other data d2 is inverted data of the data d1.

Data is encoded in the above-described manner and is wirelessly transmitted between the devices 100 and 200 placed close to each other, so that the data can be transmitted from one of the two devices 100 and 200 to the other device and an Ack signal can be transmitted from the other device to the one device using the one pair of antenna 180 and 280.

FIG. 18 illustrates a case (left portion) where a signal transmitted from the first device changes in the order of 0, 1, and 1 upon transmission of an Ack signal, serving as data “0”, from the second device and a case (right portion) where the signal transmitted from the first device changes in the order of 1, 1, and 1 upon such transmission. The middle bit of the three bits in each case corresponds to an interval for the Ack signal.

When the transmission data changes in the order of 0, 1, and 1, two waveform segments c1 and c2 upwardly project, namely, indicate positive levels in part (c) of FIG. 18. Thus, the first device can determine the presence of the Ack signal.

When the transmission data changes in the order of 1, 1, and 1, a waveform segment c3 downwardly projects and indicates a negative level and a waveform segment c4 upwardly projects and indicates a positive level in part (c) of FIG. 18. The first device can determine the presence of the Ack signal on the basis of the change in waveform. When the transmission data has another signal waveform other than those illustrated in FIG. 18, it means the absence of the Ack signal.

### 10. Modifications of Second Embodiment

Modifications of the devices included in the communication system according to the second embodiment will be described with reference to FIGS. 19 and 20.

In the modifications illustrated in FIGS. 19 and 20, the connection of the capacitors to the antennas 180 and 280 in the configuration illustrated in FIG. 16 is changed.

The modification of FIG. 19 will now be described. In the modification of FIG. 19, the capacitors 170 and 270 placed in the receiving circuits in FIG. 16 are omitted. Specifically, outputs of the transmission amplifiers 142 and 242 are connected through the capacitors 160 and 260 to the transmission/reception antennas 180 and 280, respectively, as illustrated in FIG. 19. On the other hand, the transmission/reception antennas 180 and 280 are directly connected to the comparators 141 and 241 without capacitors, respectively.

The other components are the same as those in FIG. 16.

The configuration illustrated in FIG. 19 can allow two-way wireless communication between the devices 100 and 200.

The modification of FIG. 20 will now be described.

In the modification of FIG. 20, the capacitors 160 and 260 placed in the transmitting circuits in FIG. 16 are omitted. Specifically, as illustrated in FIG. 20, outputs of the transmission amplifiers 142 and 242 are directly connected to the transmission/reception antennas 180 and 280, respectively. On the other hand, the transmission/reception antennas 180 and 280 are connected through the capacitors 170 and 270 to the comparators 141 and 241, respectively.

The other components are the same as those in FIG. 16.

The configuration illustrated in FIG. 20 can allow two-way wireless communication between the devices 100 and 200.

The present application contains subject matter related to that disclosed in Japanese Priority Patent Application JP 2009-192330 filed in the Japan Patent Office on Aug. 21, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A communication device comprising:
a transmission and reception processing unit configured to process a transmission signal and a reception signal;
a transmission amplifier configured to be supplied with a binary transmission signal switching between a high level and a low level and configured to be capable of making a choice between amplifying the transmission signal and entering a high-impedance state at an output;
an antenna configured to be supplied with a transmission signal output from the transmission amplifier;
a comparator configured to compare a signal received by the antenna with threshold values to obtain a reception signal, and supply the reception signal to the transmission and reception processing unit;
a capacitor connected to at least one of a portion between the transmission amplifier and the antenna and a portion between the antenna and the comparator; and
a control unit configured to allow the transmission amplifier to be in the high-impedance state for a period during which the transmission and reception processing unit receives a reception signal.

2. The device according to claim 1, wherein the reception signal received by the transmission and reception processing unit is a confirmation response signal relevant to a transmission signal.

3. The device according to claim 1, wherein the capacitor is provided in both of the portion between the transmission amplifier and the antenna and the portion between the antenna and the comparator.

4. The device according to claim 1, wherein
the comparator is also configured to be capable of making a choice between the operation for comparing the level of a reception signal with the threshold values and an operation for entering the high-impedance state at an input, and
the control unit allows the comparator to be in the high-impedance state for a period other than the period during which the transmission and reception processing unit receives a reception signal.

5. A communication system comprising:
a first communication device; and
a second communication device,
each of the first and second communication devices including
a transmission and reception processing unit configured to process a transmission signal and a reception signal,
a transmission amplifier configured to be supplied with a binary transmission signal switching between a high level and a low level and configured to be capable of making a choice between amplifying the transmission signal and entering a high-impedance state at an output,
an antenna configured to be supplied with a transmission signal output from the transmission amplifier, the antenna being placed close to the antenna of the other device,
a comparator configured to compare a signal received by the antenna with threshold values to obtain a reception signal, and supply the reception signal to the transmission and reception processing unit,
a capacitor connected to at least one of a portion between the transmission amplifier and the antenna and a portion between the antenna and the comparator, and
a control unit configured to allow the transmission amplifier to be in the high-impedance state for a period during which the transmission and reception processing unit receives a reception signal.

6. A method for communication, comprising the steps of:
supplying a binary transmission signal switching between a high level and a low level to an antenna through a transmission amplifier capable of making a choice between amplifying the binary transmission signal and entering a high-impedance state at an output;
comparing, in a comparator, a signal received by the antenna with threshold values to obtain a reception signal;
connecting a capacitor to at least one of a portion between the transmission amplifier and the antenna and a portion between the antenna and the comparator; and
allowing the transmission amplifier to be in the high-impedance state for a period during which a signal is received by the antenna.

7. A communication device comprising:
a transmission and reception processing unit configured to process a transmission signal and a reception signal;
a transmission amplifier configured to be supplied with a binary transmission signal switching between a high level and a low level;
an antenna configured to be supplied with a transmission signal output from the transmission amplifier;
a comparator configured to compare a signal received by the antenna with threshold values to obtain a reception signal, and supply the reception signal to the transmission and reception processing unit; and
a control unit configured to allow the transmission and reception processing unit to perform encoding such that a predetermined bit is added to a transmission signal for a period during which the transmission and reception processing unit obtains a reception signal.

8. The device according to claim 7, wherein the reception signal received by the transmission and reception processing unit is a confirmation response signal relevant to a transmission signal.

9. The device according to claim 7, wherein the predetermined bit has the same value as that of the preceding bit in the transmission signal.

10. A communication system comprising:
a first communication device; and
a second communication device,
the first communication device including
a transmission and reception processing unit configured to process a transmission signal and a reception signal,
a transmission amplifier configured to be supplied with a binary transmission signal switching between a high level and a low level,
an antenna configured to be supplied with a transmission signal output from the transmission amplifier,
a comparator configured to compare a signal received by the antenna with threshold values to obtain a reception signal, and supply the reception signal to the transmission and reception processing unit, and
a control unit configured to allow the transmission and reception processing unit to perform encoding such that a predetermined bit is added to a transmission signal for a period during which the transmission and reception processing unit obtains a reception signal,
the second communication device including
a transmission and reception processing unit configured to process a transmission signal and a reception signal,
a transmission amplifier configured to be supplied with a binary transmission signal switching between a high level and a low level,
an antenna configured to be supplied with a transmission signal output from the transmission amplifier,
a comparator configured to compare a signal received by the antenna with threshold values to obtain a reception signal, and supply the reception signal to the transmission and reception processing unit, and
a control unit configured to allow the transmission and reception processing unit to transmit a transmission signal at the time when the predetermined bit is added and perform decoding such that the predetermined bit is eliminated from a reception signal obtained by the transmission and reception processing unit.

11. A method for communication, comprising the steps of:
supplying a binary transmission signal switching between a high level and a low level to an antenna through a transmission amplifier that amplifies the binary transmission signal;
comparing, in a comparator, a signal received by the antenna with threshold values to obtain a reception signal;
connecting a capacitor to at least one of a portion between the transmission amplifier and the antenna and a portion between the antenna and the comparator; and
adding a predetermined bit to a transmission signal to be transmitted from the antenna for a period during which a reception signal is received by the antenna.
